(19) United States
(12) Patent Application Publication
(10) Pub. No.: US 2026/0348844 A1
(43) Pub. Date: Nov. 5, 2026

(54) THREE-DIMENSIONAL IMAGING SYSTEM AND METHOD USING QUASI-OPTICAL ARRAY BASED ON TERAHERTZ FREQUENCY MODULATED CONTINUOUS WAVE

(71) Applicant: Beijing Institute of Technology, Beijing (CN)

(72) Inventors: Weidong HU, Beijing (CN); Zen TAN, Beijing (CN); Huanyu JIANG, Beijing (CN); Kaiqi ZHANG, Beijing (CN); Binchao ZHANG, Beijing (CN); Chen YANG, Beijing (CN); Guiping LU, Beijing (CN)

(73) Assignee: Beijing Institute of Technology, Beijing (CN)

(21) Appl. No.: 19/146,473

(22) PCT Filed: Jan. 8, 2024
(86) PCT No.: PCT/CN2024/071002

§ 371 Date: Jul. 8, 2025

(30) Foreign Application Priority Data
Jan. 9, 2023 (CN) 202310029646.1

(51) Int. Cl. G01N 21/3581

(52) U.S. Cl. CPC G01N 21/3581

(57) ABSTRACT

The present disclosure discloses a three-dimensional imaging system and method using quasi-optical array based on terahertz frequency-modulated continuous wave. The system includes: a first terahertz radiation source (1), configured to radiate a linearly polarized first terahertz spherical beam; a collimating lens (2), configured to collimate the first terahertz spherical beam into a first plane wave, and free-space feed the first plane wave to a quasi-optical array (3); a second terahertz radiation source (4), configured to radiate a linearly polarized second terahertz spherical beam; an off-axis parabolic mirror (5), configured to collimate the second terahertz spherical beam into a second plane wave; a first reflector (6), configured to reflect the second plane wave to a beam splitter (7); the beam splitter (7), configured to reflect the second plane wave to an object of measurement (8), wherein an echo signal generated by reflection of a reflected second plane wave on the object of measurement (8) is free-space fed to the quasi-optical array (3); and an imaging device, configured to acquire a local oscillator signal and an echo signal of each array unit at the quasi-optical array (3), and perform real-time three-dimensional imaging. The system increases the speed of imaging greatly, and the way of feeding to quasi-optical array is more suitable to an integration of terahertz array in a large scale without complicated power distribution feeding network.

### TECHNICAL FIELD

The present disclosure relates to the field of imaging based on terahertz, and more specifically, to a three-dimensional imaging system and method using quasi-optical array based on terahertz frequency-modulated continuous wave.

### BACKGROUND

Terahertz waves are widely used in non-destructive testing, security check, medical treatment, communications and other fields due to their unique properties such as penetrability, safety, and high resolution. In a field of imaging based on terahertz, imaging based on terahertz time-domain spectral has attracted much attention from researchers due to its advantages such as wide spectrum and high resolution.

Prior imaging by using terahertz frequency-modulated continuous wave are mostly single-input single-output imaging systems. Such method is limited in application due to slow imaging and limited penetration depth. In order to increase the imaging speed, relevant research has been conducted on imaging using terahertz array, e.g., detectors using pyroelectric array and detectors using semiconductor nonlinear array have been proposed as mature technical solutions. The detectors using pyroelectric array convert a terahertz wave signal into a readable voltage signal by detection materials, and the voltage signal is proportional to a power of terahertz wave. The detectors using semiconductor nonlinear array complete a frequency conversion function by mainly using the nonlinearity of contact materials, so as to realize the reception and detection of terahertz waves. However, both the above technical solutions are only applicable to two-dimensional imaging systems.

For imaging using three-dimensional array based on heterodyne detection and terahertz, relevant research has been conducted by e.g., Jet Propulsion Laboratory in the United States proposing a multiple-input multiple-output (MIMO) terahertz imaging system. However, the system requires a complex power distribution feed network, which greatly increases the complexity and cost of the system.

### BRIEF SUMMARY

In view of this, the embodiments of the present disclosure provide a three-dimensional imaging system and method using quasi-optical array based on terahertz frequency-modulated continuous wave to address at least part of the current problems in the prior art.

In a first aspect, an embodiment of the present disclosure provides a three-dimensional imaging system using quasi-optical array based on terahertz frequency-modulated continuous wave, including:
a first terahertz radiation source, configured to radiate a linearly polarized first terahertz spherical beam;
a collimating lens, configured to receive the first terahertz spherical beam, collimate the first terahertz spherical beam into a first plane wave, and free-space feed the first plane wave to a quasi-optical array as a local oscillator signal;
a second terahertz radiation source, configured to radiate a linearly polarized second terahertz spherical beam;
an off-axis parabolic mirror, configured to receive the second terahertz spherical beam, and collimate the second terahertz spherical beam into a second plane wave;
a first reflector, configured to reflect the second plane wave to a beam splitter;
the beam splitter, configured to reflect the second plane wave to an object of measurement, wherein an echo signal generated by reflection of a reflected second plane wave on the object of measurement is transmitted through the beam splitter and then free-space fed to the quasi-optical array; and
an imaging device, configured to acquire a local oscillator signal and an echo signal of each array unit at the quasi-optical array, and perform real-time three-dimensional imaging according to the local oscillator signal and the echo signal of each array unit.

According to an embodiment of the present disclosure, the system further includes a wave-absorbing material, configured to absorb the second plane wave transmitted through the beam splitter.

According to an embodiment of the present disclosure, the system further includes a second reflector, disposed between the beam splitter and the quasi-optical array, and configured to reflect the echo signals from the beam splitter to the quasi-optical array.

According to an embodiment of the present disclosure, the first reflector and the second reflector are gold-plated reflectors.

In a second aspect, an embodiment of the present disclosure provides a three-dimensional imaging method using quasi-optical array based on terahertz frequency-modulated continuous wave including:
acquiring a local oscillator signal S_{T}(t) and an echo signal S_{RF}(t) of each array unit at a quasi-optical array by a multi-channel data acquisition card;
performing frequency filtering on the local oscillator signal S_{T}(t) and the echo signal S_{RF}(t) to obtain an intermediate frequency signal

$${S}_{ZF}^{n} ( t )$$

of each array unit;
performing consistency-calibrating on amplitude of each intermediate frequency signal

$${S}_{ZF}^{n} ( t )$$

by means of an object with high reflectivity to obtain calibrated intermediate frequency signals

$${S}_{ZF}^{{n}^{′}} ( t ) ;$$

obtaining a covariance matrix

$${R}_{ss}^{n}$$

of calibrated intermediate frequency signals

$${S}_{ZF}^{{n}^{′}} ( t ) ;$$

performing eigenvalue decomposition on the covariance matrix

$${R}_{ss}^{n} ;$$

constructing a search function for frequency components according to the decomposed eigenvalues, and outputting high-resolution range distributions Pⁿ; and
stitching the range distributions Pⁿ in sequence based on an ordering of the array units to obtain a high-resolution three-dimensional imaging result of the object of measurement.

According to an embodiment of the present disclosure, a transmission signal S_{T}(t), the echo signal S_{RF}(t), and the intermediate frequency signal

$${S}_{ZF}^{n} ( t )$$

of each array unit are expressed as follows:

S_{T}(t)=exp([j2π(f₀t+½Kt₂)]

S_{RF}(t)=exp[j2π(f₀(t−τ)+½K(t−τ)²)]

$${S}_{ZF}^{n} ( t ) = r e c t ( t ) \cdot {A}^{n} exp [ j 2 π ( {f}_{0} τ + K t τ - 1 / 2 K {τ}^{2} ) ]$$

where f₀ is a starting frequency fro frequency sweep, τ=2R/c is an echo time delay caused by the object of measurement, R is a distance of the object of measurement from a radar, c is the speed of light; K=B/T is a frequency modulation slope, B is a signal bandwidth, T is a signal frequency modulation period; and n=[1, . . . , n] is the ordering number of the array units.

According to an embodiment of the present disclosure, the performing consistency-calibrating on amplitude of each intermediate frequency signal

$${S}_{ZF}^{n} ( t )$$

by means of the object with high reflectivity to obtain the calibrated intermediate frequency signals

$${S}_{ZF}^{{n}^{′}} ( t )$$

includes:
adjusting an amplitude of the intermediate frequency signal

$${S}_{ZF}^{n} ( t )$$

of each array unit by means of the object with high reflectivity so that the intermediate frequency signal

$${S}_{ZF}^{n} ( t )$$

of each array unit has the amplitude approximately equal to each other, when

$${A}_{j}^{n} \cdot {A}^{n} = {A}^{1} ,$$

the calibrated array intermediate frequency signals

$${S}_{ZF}^{{n}^{′}} ( t ) = {A}_{J}^{n} {S}_{ZF}^{n} ( t )$$

is obtained.

According to an embodiment of the present disclosure, the covariance matrix

$${R}_{ss}^{n}$$

is expressed as follows:

$${R}_{ss}^{n} = cov ( {S}_{ZF}^{{n}^{′}} ( t ) , {S}_{ZF}^{{n}^{′}} ( t ) )$$

where cov(⋅) represents a covariance solution.

According to an embodiment of the present disclosure, the performing eigenvalue decomposition on the covariance matrix

$${R}_{ss}^{n}$$

includes:
performing eigenvalue decomposition on the covariance matrix

$${R}_{ss}^{n}$$

and reordering corresponding eigenvectors in descending order by eigenvalue;

$${R}_{ss}^{n} = {\sum }^{N} {λ}_{i} {u}_{i} {u}_{i}^{H}$$

where N is the size of the matrix

$${R}_{ss}^{n}$$

λᵢ is the eigenvalue in descending order, satisfying λ₁>λ₂> . . . >λ_{N}, and uᵢ is the normalized eigenvector corresponding to λᵢ.

According to an embodiment of the present disclosure, the high-resolution range distribution Pⁿ is expressed as follows:

$${P}^{n} = \frac{1}{{a}^{H} ( ω ) {U}_{N} {U}_{N}^{H} a ( ω )}$$

where aᵢ=[1,exp(−jωᵢ), . . . , exp(−jωᵢ(N−1))] is a frequency vector of a signal, ωᵢ∈[0,2π] is a normalized frequency component, U_{N}=[u₁, u₂, . . . , u_{N}], and H is a conjugate transpose operation.

In summary, the three-dimensional imaging system using quasi-optical array based on terahertz frequency-modulated continuous wave according to embodiments of the present disclosure may perform real-time scanning and imaging on a object of measurement based on a spherical wave quasi-optical structure and the detection by a quasi-optical array, without need of mechanical movement to scan the object of measurement, so that the efficiency of scanning and imaging is greatly improved.

Compared to the imaging solutions using frequency-modulated continuous wave based on terahertz in the prior art, according to this embodiment, not only the speed of imaging is increased, but also a quasi-optical feed mode is more applicable to large-scale terahertz array integration and does not require a complex power distribution feed network, and can be used in three-dimensional imaging fields such as real-time terahertz non-destructive testing and security check.

### BRIEF DESCRIPTION OF THE DRAWINGS

In order to more clearly illustrate the technical solutions of the embodiments of the present disclosure, the accompanying drawings required for use in the embodiments will be briefly introduced below. It is apparent that the accompanying drawings described below are merely some embodiments of the present disclosure. For those of ordinary skill in the art, other accompanying drawings can be obtained based on these accompanying drawings without creative efforts.

FIG. 1 is a schematic diagram of a three-dimensional imaging system using quasi-optical array based on terahertz frequency-modulated continuous wave according to a first embodiment of the present disclosure;

FIG. 2 is a schematic diagram of a quasi-optical array; and

FIG. 3 is a schematic flowchart of a three-dimensional imaging method using quasi-optical array based on terahertz frequency-modulated continuous wave according to a second embodiment of the present disclosure.

### DETAILED DESCRIPTION

The embodiments of the present disclosure are described in detail below with reference to the accompanying drawings.

The following describes the implementations of the present disclosure through specific examples, and those skilled in the art can easily understand other advantages and effects of the present disclosure from the contents disclosed in this specification. It is apparent that the described embodiments are merely some, rather than all, of the embodiments of the present disclosure. The present disclosure may also be implemented or applied through other different specific implementations, and the details in this specification may also be modified or changed in various ways based on different viewpoints and applications without departing from the spirit of the present disclosure. It is to be noted that the following embodiments and features therein may be combined with each other in the absence of conflict. Based on the embodiments in the present disclosure, all other embodiments obtained by those of ordinary skill in the art without any creative effort shall fall within the scope of protection of the present disclosure.

It is to be noted that various aspects of the embodiments that are within the scope of the appended claims are described below. It should be apparent that the aspects described herein may be embodied in a wide variety of forms and that any specific structure and/or function described herein is merely illustrative. Based on the present disclosure, those skilled in the art should appreciate that one aspect described herein may be implemented independently of any other aspects and that two or more of these aspects may be combined in various ways. For example, a device may be implemented and/or a method may be practiced using any number of the aspects set forth herein. In addition, such a device may be implemented and/or such a method may be practiced using other structure and/or functionality in addition to or in addition to one or more of the aspects set forth herein.

It is also to be noted that the illustrations provided in the following embodiments are merely schematic illustrations of the basic concept of the present disclosure. The drawings merely show components related to the present disclosure rather than being drawn based on the number, shape and size of components in actual implementation. In actual implementation, the type, quantity and proportion of various components may be changed arbitrarily, and the component layout may also be more complicated.

Furthermore, specific details are provided to facilitate a thorough understanding of the examples in the following description. However, those skilled in the art will understand that the aspects may be practiced without these specific details.

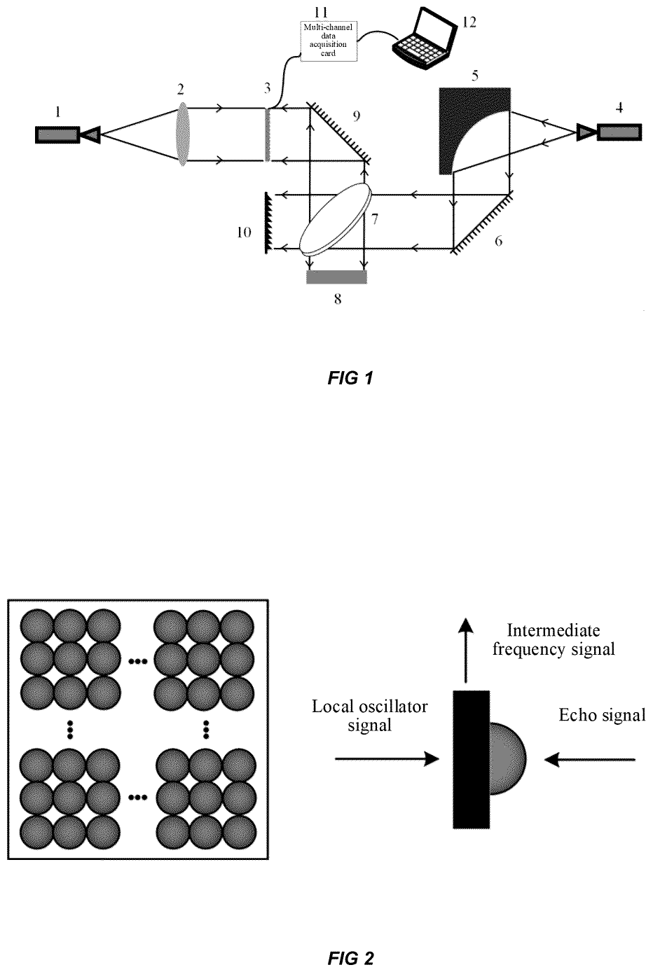

Referring to FIG. 1, the first embodiment of the present disclosure provides a three-dimensional imaging system using quasi-optical array based on terahertz frequency-modulated continuous wave. The system includes a first terahertz radiation source 1, a collimating lens 2, a second terahertz radiation source 4, an off-axis parabolic mirror 5, a first reflector 6, a beam splitter 7, and an imaging device.

The first terahertz radiation source 1 is configured to radiate a linearly polarized first terahertz spherical beam.

In this embodiment, terahertz (THz) waves refer to electromagnetic waves with a frequency in the range of 0.1 to 10 THz (wavelength of 3000 to 30 μm). The electromagnetic waves coincide with millimeter waves in a long wave band and with infrared light in a short wave band, which is a transition zone from macroscopic classical theory to microscopic quantum theory.

In this embodiment, a spherical wave refers to a wave field whose wave front or wave surface is a sphere. During propagation, the waveform of the spherical wave remains unchanged, and the amplitude decays inversely proportional to the distance to the center of the sphere.

The collimating lens 2 is configured to receive the first terahertz spherical beam, collimate the first terahertz spherical beam into a first plane wave, and free-space feed the first plane wave to a quasi-optical array 3 as a local oscillator signal.

In this embodiment, the collimating lens 2 is a terahertz-based collimating lens, which may collimate the first terahertz spherical beam into a first plane wave. The first plane wave is free-space fed to the quasi-optical array 3 as a local oscillator signal for subsequent three-dimensional imaging.

The second terahertz radiation source 4 is configured to radiate a linearly polarized second terahertz spherical beam.

The off-axis parabolic mirror 5 is configured to receive the second terahertz spherical beam, and collimate the second terahertz spherical beam into a second plane wave.

In this embodiment, the off-axis parabolic mirror 5 is one of the elements generally used for constructing a terahertz optical path, and based on the principle of geometric parabola, and can focus a parallel incident collimated beam/collimated THz wave to a focal point and further convert a terahertz spherical wave emitted by a point light source into a parallel beam. The material of the base of the off-axis parabolic mirror 5 is generally metallic aluminium, and the surface is processed using a precision metal tool. Therefore, an off-axis paraboloid works based on the principle of reflection, which can eliminate phase delays and absorption loss of transmission optical elements.

The first reflector 6 is configured to reflect the second plane wave to a beam splitter 7.

The beam splitter 7 is configured to reflect the second plane wave to a object of measurement 8, an echo signal generated by reflection of the reflected second plane wave on the object of measurement 8 is transmitted through the beam splitter 7 and then free-space fed to the quasi-optical array 3.

In this embodiment, the beam splitter 7 is primarily configured to split the second plane wave into two beams of transmitted light and reflected light with a certain ratio of light intensity. The beam splitter 7 is usually tilted, and may separate the second plane wave into two portions, i.e., reflected light and transmitted light. The reflected portion of the second plane wave may be guided to the object of measurement 8, and the echo signal generated by reflection on the object of measurement 8 will reach the beam splitter 7 again, and may be transmitted through the beam splitter 7 and then free-space fed to the quasi-optical array 3.

In particular, in a preferred embodiment, the system further includes a second reflector 9.

The second reflector 9 is disposed between the beam splitter 7 and the quasi-optical array 3, and is configured to reflect the echo signals from the beam splitter 7 to the quasi-optical array 3.

In particular, the first reflector 6 and the second reflector 9 are gold-plated reflectors.

In particular, in a preferred embodiment, in order to prevent the transmitted second plane wave from interfering with the entire system, a wave-absorbing material 10 may be provided on an optical path of the transmitted light to absorb the portion of the second plane wave that transmits through the beam splitter 7.

The imaging device is configured to acquire local oscillator signals and echo signals at the quasi-optical array 3, and perform real-time three-dimensional imaging according to the local oscillator signals and the echo signals.

As shown in FIG. 2, in this embodiment, the quasi-optical array 3 is a microlens array, which is an array composed of lenses with a clear aperture and a relief depth at micrometer. The microlens array is composed of a series of array units provided in a predetermined order. Each array unit may be a spherical lens, an aspherical lens, a cylindrical lens, a prism, etc., configured to realize focusing, imaging, beam transformation and other functions at a micro-optical angle.

In this embodiment, each array unit in the quasi-light array 3 may receive the local oscillator signals S_{T}(t) and the echo signals S_{RF}(t), and perform the collimation on beams.

In this embodiment, the imaging device includes a multi-channel data acquisition card 11 and a host computer 12.

The multi-channel data acquisition card 11 is configured to acquire local oscillator signals S_{T}(t) and echo signals S_{RF}(t) at the quasi-optical array.

In this embodiment, the multi-channel data acquisition card has a plurality of acquisition channels, so that a local oscillator signal S_{T}(t) and an echo signal S_{RF}(t) of each array unit in the quasi-optical array 3 may be acquired through the multiple acquisition channels, respectively, and then the local oscillator signals S_{T}(t) and the echo signals S_{RF}(t) are transmitted to the host computer 12. The host computer 12 may perform real-time three-dimensional imaging on the object of measurement 8 according to the local oscillator signals S_{T}(t) and the echo signals S_{RF}(t).

In summary, the three-dimensional imaging system using quasi-optical array based on terahertz frequency-modulated continuous wave according to an embodiment of the present disclosure may perform real-time scanning and imaging on a object of measurement based on a spherical wave quasi-optical structure and the detection by a quasi-optical array, without need of mechanical movement to scan the object of measurement, so that the efficiency of scanning and imaging is greatly improved.

Compared to the imaging solutions using frequency-modulated continuous wave based on terahertz in the prior art, according to this embodiment, not only the speed of imaging is increased, but also a quasi-optical feed mode is more applicable to large-scale terahertz array integration and does not require a complex power distribution feed network, and can be used in three-dimensional imaging fields such as real-time terahertz non-destructive testing and security check.

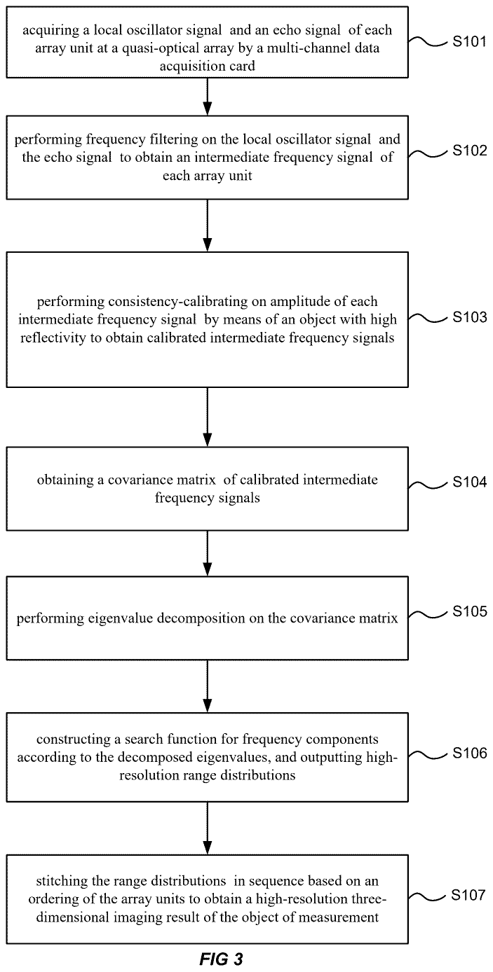

Referring to FIG. 3, a second embodiment of the present disclosure provides a three-dimensional imaging method using quasi-optical array based on terahertz frequency-modulated continuous wave, which is based on the three-dimensional imaging system using quasi-optical array based on terahertz frequency-modulated continuous wave according to any of the above embodiments. The imaging method may be implemented by a host computer in the three-dimensional imaging system using quasi-optical array based on terahertz frequency-modulated continuous wave, and includes the following steps:

S101, acquiring a local oscillator signal S_{T}(t) and an echo signal S_{RF}(t) of each array unit at a quasi-optical array by a multi-channel data acquisition card.

S102, performing frequency filtering on the local oscillator signal S_{T}(t) and the echo signal S_{RF}(t) to obtain an intermediate frequency signal

$${S}_{ZF}^{n} ( t )$$

of each array unit.

In this embodiment, the frequency filtering is mainly used for mixing filtering and denoising.

In this embodiment, a transmission signal S_{T}(t), the echo signal S_{RF}(t), and the intermediate frequency signal

$${S}_{ZF}^{n} ( t )$$

of each array unit are expressed as follows:

S_{T}(t)=exp[j2π(f₀t+½Kt²)]

S_{RF}(t)=exp[j2π(f₀(t−τ)+½K(t−τ)²)]

$${S}_{ZF}^{n} ( t ) = rect ( t ) \cdot {A}^{n} exp [ j 2 π ( {f}_{0} τ + Kt τ - 1 / 2 K {τ}^{2} ) ]$$

where f₀ is a starting frequency fro frequency sweep, τ=2R/c is an echo time delay caused by the object of measurement, R is a distance of the object of measurement from a radar, c is the speed of light; K=B/T is a frequency modulation slope, B is a signal bandwidth, T is a signal frequency modulation period; and n=[1, . . . , n] is the ordering number of the array units.

S103, performing consistency-calibrating on amplitude of each intermediate frequency signal

$${S}_{ZF}^{n} ( t )$$

by means of an object with high reflectivity to obtain calibrated intermediate frequency signals

$${S}_{ZF}^{{n}^{′}} ( t )$$

Specifically, the amplitude of the intermediate frequency signal

$${S}_{ZF}^{n} ( t )$$

of each array unit may be adjusted by means of the object with high reflectivity (such as a metal plate) the intermediate frequency signal

$${S}_{ZF}^{n} ( t )$$

of each array unit has the amplitude approximately equal to each other, when

$${A}_{j}^{n} \cdot {A}^{n} = {A}^{1} ,$$

the calibrated array intermediate frequency signals

$${S}_{ZF}^{{n}^{′}} ( t ) = {A}_{J}^{n} {S}_{ZF}^{n} ( t )$$

is obtained.

S104, obtaining a covariance matrix

$${R}_{ss}^{n}$$

of calibrated intermediate frequency signals

$${S}_{ZF}^{{n}^{′}} ( t )$$

The covariance matrix

$${R}_{ss}^{n}$$

is expressed as follows:

$${R}_{ss}^{n} = cov ( {S}_{ZF}^{{n}^{′}} ( t ) , {S}_{ZF}^{{n}^{′}} ( t ) )$$

where cov(⋅) represents a covariance solution.

S105, performing eigenvalue decomposition on the covariance matrix

$${R}_{ss}^{n}$$

Specifically, eigenvalue decomposition is conducted on the covariance matrix

$${R}_{ss}^{n}$$

and corresponding eigenvectors are reordered in descending order by eigenvalue;

$${R}_{ss}^{n} = {\sum }^{N} {λ}_{i} {u}_{i} {u}_{i}^{H}$$

where N is the size of the matrix

$${R}_{s s}^{n} ,$$

λᵢ is the eigenvalue in descending order, satisfying λ₁>λ₂> . . . >λ_{N}, and uᵢ is the normalized eigenvector corresponding to λᵢ.

S106, constructing a search function for frequency components according to the decomposed eigenvalues, and outputting a high-resolution range distributions Pⁿ.

The high-resolution range distribution Pⁿ is expressed as follows:

$${P}^{n} = \frac{1}{{a}^{H} ( ω ) {U}_{N} {U}_{N}^{H} a ( ω )}$$

where aᵢ=[1,exp(−jωᵢ), . . . , exp(−jωᵢ(N−1))] is a frequency vector of a signal, ωᵢ∈[0,2π] is a normalized frequency component, U_{N}=[u₁, u₂, . . . , u_{N}], and H is a conjugate transpose operation.

S107, stitching the range distributions Pⁿ in sequence based on an ordering of the array units to obtain a high-resolution three-dimensional imaging result of the object of measurement.

In this embodiment, the range distributions Pⁿ are stitched in sequence based on the ordering of the array units (as shown in FIG. 2) upon the range distribution Pⁿ of each array unit is obtained, so that a three-dimensional imaging result of the object of measurement in high solution may be obtained.

Based on the three-dimensional imaging method using quasi-optical array based on terahertz frequency-modulated continuous wave in this embodiment, range distributions Pⁿ are acquired in high solution by constructing a search function of frequency components, so that a three-dimensional imaging result in high solution may be obtained, so that the clarity by imaging is improved.

The above description is merely embodiments of the present disclosure, but the scope of the present disclosure is not limited thereto. Any changes or substitutions that can be easily conceived by any skilled familiar in the technical field within the technical scope disclosed in the present disclosure should be covered by the scope of protection of the present disclosure. Therefore, the scope of protection of the present disclosure should be based on the scope of protection of the claims.

1. A three-dimensional imaging system using quasi-optical array based on terahertz frequency-modulated continuous wave, comprising:
a first terahertz radiation source, configured to radiate a linearly polarized first terahertz spherical beam;
a collimating lens, configured to receive the first terahertz spherical beam, collimate the first terahertz spherical beam into a first plane wave, and free-space feed the first plane wave to a quasi-optical array as a local oscillator signal;
a second terahertz radiation source, configured to radiate a linearly polarized second terahertz spherical beam;
an off-axis parabolic mirror, configured to receive the second terahertz spherical beam, and collimate the second terahertz spherical beam into a second plane wave;
a first reflector, configured to reflect the second plane wave to a beam splitter;
the beam splitter, configured to reflect the second plane wave to an object of measurement, wherein an echo signal generated by reflection of a reflected second plane wave on the object of measurement is transmitted through the beam splitter and then free-space fed to the quasi-optical array; and
an imaging device, configured to acquire a local oscillator signal and an echo signal of each array unit at the quasi-optical array, and perform real-time three-dimensional imaging according to the local oscillator signal and the echo signal of each array unit.

2. The three-dimensional imaging system using quasi-optical array based on terahertz frequency-modulated continuous wave according to claim 1, further comprises a wave-absorbing material, configured to absorb the second plane wave transmitted through the beam splitter.

3. The three-dimensional imaging system using quasi-optical array based on terahertz frequency-modulated continuous wave according to claim 2, further comprises a second reflector, disposed between the beam splitter and the quasi-optical array, and configured to reflect the echo signals from the beam splitter to the quasi-optical array.

4. The three-dimensional imaging system using quasi-optical array based on terahertz frequency-modulated continuous wave according to claim 3, wherein the first reflector and the second reflector are gold-plated reflectors.

5. A three-dimensional imaging method using quasi-optical array based on terahertz frequency-modulated continuous wave, comprising:
acquiring a local oscillator signal S_{T}(t) and an echo signal S_{RF}(t) of each array unit at a quasi-optical array by a multi-channel data acquisition card;
performing frequency filtering on the local oscillator signal S_{T}(t) and the echo signal S_{RF}(t) to obtain an intermediate frequency signal
$${S}_{ZF}^{n} ( t )$$
of each array unit;
performing consistency-calibrating on amplitude of each intermediate frequency signal
$${S}_{ZF}^{n} ( t )$$
by means of an object with high reflectivity to obtain calibrated intermediate frequency signals
$${S}_{ZF}^{{n}^{′}} ( t )$$
obtaining a covariance matrix
$${R}_{ss}^{n}$$
of calibrated intermediate frequency signals
$${S}_{ZF}^{{n}^{′}} ( t )$$
performing eigenvalue decomposition on the covariance matrix
$${R}_{ss}^{n}$$
constructing a search function for frequency components according to the decomposed eigenvalues, and outputting high-resolution range distributions Pⁿ; and
stitching the range distributions Pⁿ in sequence based on an ordering of the array units to obtain a high-resolution three-dimensional imaging result of the object of measurement.

6. The three-dimensional imaging method using quasi-optical array based on terahertz frequency-modulated continuous wave according to claim 5, wherein a transmission signal S_{T}(t), the echo signal S_{RF}(t), and the intermediate frequency signal
$${S}_{ZF}^{n} ( t )$$
of each array unit are expressed as follows:
S_{T}(t)=exp[j2π(f₀t+½Kt²)]
S_{RF}(t)=exp[j2π(f₀(t−τ)+½K(t−τ)²)]
$${S}_{ZF}^{n} ( t ) = rect ( t ) \cdot {A}^{n} exp [ j 2 π ( {f}_{0} τ + Kt τ - 1 / 2 K {τ}^{2} ) ]$$
where f₀ is a starting frequency fro frequency sweep, τ=2R/c is an echo time delay caused by the object of measurement, R is a distance of the object of measurement from a radar, c is the speed of light; K=B/T is a frequency modulation slope, B is a signal bandwidth, T is a signal frequency modulation period; n=[1, . . . , N̅] is the ordering number of the array units, and N̅ is the total number of the array units.

7. The three-dimensional imaging method using quasi-optical array based on terahertz frequency-modulated continuous wave according to claim 6, wherein the performing consistency-calibrating on amplitude of each intermediate frequency signal
$${S}_{ZF}^{n} ( t )$$
by means of the object with high reflectivity to obtain the calibrated intermediate frequency signals
$${S}_{ZF}^{{n}^{′}} ( t )$$
comprises:
adjusting an amplitude of the intermediate frequency signal
$${S}_{ZF}^{n} ( t )$$
of each array unit by means of the object with high reflectivity so that the intermediate frequency signal
$${S}_{ZF}^{n} ( t )$$
of each array unit has the amplitude approximately equal to each other, and
$${A}_{j}^{n} \cdot {A}^{n} = {A}^{1} ,$$
so that the calibrated array intermediate frequency signals
$${S}_{ZF}^{{n}^{′}} ( t ) = {A}_{J}^{n} {S}_{ZF}^{n} ( t )$$
is obtained.

8. The three-dimensional imaging method using quasi-optical array based on terahertz frequency-modulated continuous wave according to claim 7, wherein the covariance matrix
$${R}_{ss}^{n}$$
is expressed as follows:
$${R}_{ss}^{n} = cov ( {S}_{ZF}^{{n}^{′}} ( t ) , {S}_{ZF}^{{n}^{′}} ( t ) )$$
where cov(⋅) represents a covariance solution.

9. The three-dimensional imaging method using quasi-optical array based on terahertz frequency-modulated continuous wave according to claim 8, wherein the performing eigenvalue decomposition on the covariance matrix
$${R}_{ss}^{n}$$
comprises:
performing eigenvalue decomposition on the covariance matrix
$${R}_{s s}^{n} ,$$
and reordering corresponding eigenvectors in descending order by eigenvalue;
$${R}_{ss}^{n} = {\sum }^{N} {λ}_{i} {u}_{i} {u}_{i}^{H}$$
where N is the size of the matrix
$${R}_{ss}^{n} ,$$
λᵢ is the eigenvalue in descending order, satisfying λ₁>λ₂> . . . >λ_{N}, and uᵢ is the normalized eigenvector corresponding to λᵢ.

10. The three-dimensional imaging method using quasi-optical array based on terahertz frequency-modulated continuous wave according to claim 9, wherein the high-resolution range distribution Pⁿ is expressed as follows:
$${P}^{n} = \frac{1}{{a}^{H} ( ω ) {U}_{N} {U}_{N}^{H} a ( ω )}$$
where α(ω)=[1,exp(−jω), . . . , exp(−jω(N−1))] is a frequency vector of a signal, ω∈[0,2π] is a normalized frequency component, U_{N}=[u₁, u₂, . . . , u_{N}], and H is a conjugate transpose operation.
